(19) United States
(12) Patent Application Publication
(10) Pub. No.: US 2026/0302008 A1
(43) Pub. Date: Oct. 1, 2026

(54) TRANSIENT VOLTAGE PROTECTION DEVICE

(71) Applicant: TDK CORPORATION, Tokyo (JP)

(72) Inventors: Yoshihiro SHINKAI, Tokyo (JP); Naoyoshi YOSHIDA, Tokyo (JP); Masato HAYATSU, Tokyo (JP); Shunsuke TAKAHASHI, Tokyo (JP); Sota HIRABA, Tokyo (JP); Jun SATO, Tokyo (JP); Masato TAKAHASHI, Tokyo (JP)

(73) Assignee: TDK CORPORATION, Tokyo (JP)

(21) Appl. No.: 19/574,950

(22) Filed: Mar. 23, 2026

(30) Foreign Application Priority Data
Mar. 25, 2025 (JP) 2025-050019
Jan. 30, 2026 (JP) 2026-014881

(51) Int. Cl. H01C 7/12; H01C 1/14

(52) U.S. Cl. CPC H01C 7/12; H01C 1/14

(57) ABSTRACT

A transient voltage protection device includes discharge electrodes in pairs apart with a gap therebetween and a discharge inducing portion having a surface exposed to the gap and being in contact with the discharge electrodes in pairs. The discharge inducing portion includes a ceramic component and metal particles. The surface of the discharge inducing portion between the discharge electrodes in pairs has a surface roughness Sa of 100 nm or more and 500 nm or less.

### BACKGROUND OF THE INVENTION

The present disclosure relates to a transient voltage protection device.

### BACKGROUND

In recent years, as electronic equipment has been having smaller size and higher performance, importance has been attached to electronic devices for protecting circuits from transient voltages, such as electrostatic discharge (ESD). For example, Patent Document 1 discloses a transient voltage protection device (what is commonly referred to as an ESD suppressor) including a pair of discharge electrodes opposing each other and a discharge inducing portion adjacent to the discharge electrodes. A transient voltage protection device such as that disclosed in Patent Document 1 can have smaller capacitance than that of other ESD protection elements (e.g., multilayer varistors and Zener diodes), being suitable for high-speed transmission circuits, high-frequency circuits, or the like.

However, electronic equipment has increasingly been required to have a higher transmission speed and a lower drive voltage. To respond to these requirements, a demand for a transient voltage protection device to have a lower discharge start voltage and higher ESD resistance has been rising.

### PRIOR ART DOCUMENT

### Patent Document

[Patent Document 1] WO 2009/098944

### BRIEF SUMMARY OF THE INVENTION

### Means for Solving the Problem

A transient voltage protection device according to the present disclosure is
a transient voltage protection device including
discharge electrodes in pairs apart with a gap therebetween; and
a discharge inducing portion having a surface exposed to the gap and being in contact with the discharge electrodes in pairs,
wherein
the discharge inducing portion includes a ceramic component and metal particles, and
the surface of the discharge inducing portion between the discharge electrodes in pairs has a surface roughness Sa of 100 nm or more and 500 nm or less.

### BRIEF DESCRIPTION OF THE SEVERAL VIEWS OF THE DRAWING

FIG. 1 is a perspective view of a transient voltage protection device according to one embodiment of the present disclosure.

FIG. 2A is a cross-sectional view along a line IIA-IIA illustrated in FIG. 1.

FIG. 2B is a cross-sectional view along a line IIB-IIB illustrated in FIG. 1.

FIG. 3 is a schematic cross-sectional view of a discharge inducing portion.

FIG. 4 is a plan view of a green sheet used in a manufacturing process of the transient voltage protection device.

FIG. 5 is an exploded perspective view of a green chip used in the manufacturing process of the transient voltage protection device.

FIG. 6A is a cross-sectional view of a modified example of the transient voltage protection device.

FIG. 6B is a cross-sectional view of another modified example of the transient voltage protection device.

### DETAILED DESCRIPTION OF THE INVENTION

It is an object of an exemplary embodiment of the present disclosure to provide a transient voltage protection device having a low discharge start voltage and high ESD resistance.

In the transient voltage protection device of the present disclosure, the ceramic component of the discharge inducing portion may include glass predominantly containing SiO₂, ceramic particles predominantly containing Al₂O₃, and oxide particles having a higher permittivity than that of the glass and the ceramic particles.

In the transient voltage protection device of the present disclosure, the ceramic particles predominantly containing Al₂O₃ may have a D50 of 0.20 μm or more and 1.26 μm or less in a cross-section of the discharge inducing portion.

In the transient voltage protection device of the present disclosure,
the ceramic particles predominantly containing Al₂O₃ may have a D50 of 0.20 μm or more and 0.50 μm or less in a cross-section of the discharge inducing portion,
the glass predominantly containing SiO₂ may at least partly include glass particles predominantly containing Si, and
the glass particles predominantly containing Si may have a D50 of 0.20 μm or more and 0.50 μm or less.

In the transient voltage protection device of the present disclosure, the oxide particles may contain an oxide of at least one element selected from the group consisting of Ti and Zr.

In the transient voltage protection device of the present disclosure, the metal particles may predominantly contain at least one selected from the group consisting of Ag, Au, Pd, and Pt.

In the transient voltage protection device of the present disclosure, the discharge electrodes may predominantly contain at least one selected from the group consisting of Ag, Au, Pd, and Pt.

In the transient voltage protection device of the present disclosure, the surface of the discharge inducing portion may have an Sz of 400 nm or more and 2500 nm or less.

In the transient voltage protection device of the present disclosure, the surface of the discharge inducing portion may have an Ra of 95 nm or more and 500 nm or less.

In the transient voltage protection device of the present disclosure, the surface of the discharge inducing portion may have an Rz of 400 nm or more and 2500 nm or less.

In the transient voltage protection device of the present disclosure, the metal particles may have a median size of 2.0 μm or less in a cross-section of the discharge inducing portion.

In the transient voltage protection device of the present disclosure, the metal particles may occupy a total area percentage of 10% or more and 50% or less of a cross-section of the discharge inducing portion.

In the transient voltage protection device of the present disclosure, the glass may be included in the discharge inducing portion by 15 wt % or more and 60 wt % or less out of 100 wt % of the ceramic component of the discharge inducing portion.

In the transient voltage protection device of the present disclosure, SiO₂ contained in the glass may constitute 1 wt % to 60 wt % out of 100 wt % of the ceramic component of the discharge inducing portion.

In the transient voltage protection device of the present disclosure, the metal particles may have a median size of 2.0 μm or less in a cross-section of the discharge inducing portion.

In the transient voltage protection device of the present disclosure, the metal particles may occupy a total area percentage of 10% or more and 50% or less of a cross-section of the discharge inducing portion.

An embodiment of the present disclosure is described below with reference to the drawing. The embodiment of the present disclosure described below is an exemplification illustrative of the present disclosure; and constituents of the embodiment, such as numerical values, shapes, materials, and manufacturing steps, may be modified or changed to the extent that technical problems do not arise. Shapes and the like illustrated in the drawing of the present disclosure do not necessarily match actual shapes and dimensions. This is because the shapes and dimensions in the drawing may be modified for illustration purposes.

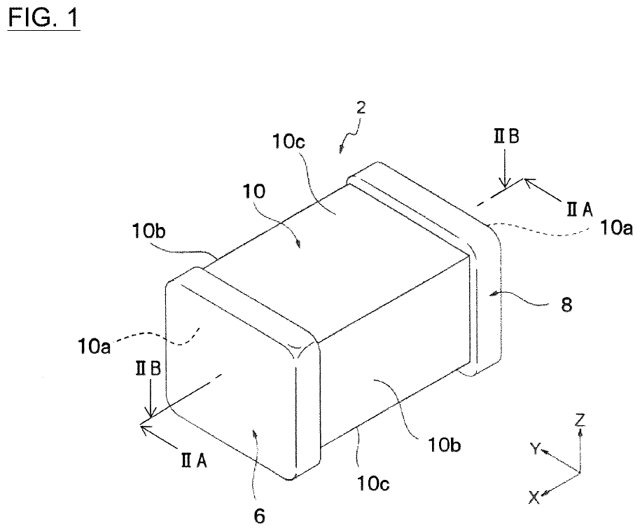

As illustrated in FIG. 1, a transient voltage protection device 2 according to the present embodiment includes an element body 10 having a hexahedral shape (rectangular parallelepiped shape) and external electrodes (a first external electrode 6 and a second external electrode 8) in pairs provided at outer surfaces of the element body 10.

The element body 10 includes end surfaces 10a in pairs substantially perpendicular to the X-axis, side surfaces 10b in pairs substantially perpendicular to the Y-axis, and main surfaces 10c in pairs substantially perpendicular to the Z-axis. Dimensions of the element body 10 are not limited and are appropriately determined according to a use. In the drawing, the X-axis, the Y-axis, and the Z-axis are substantially perpendicular to each other.

The first external electrode 6 covers one end surface 10a and extends from the end surface 10a to part of the side surfaces 10b and part of the main surfaces 10c. The second external electrode 8 covers the other end surface 10a and extends from the end surface 10a to part of the side surfaces 10b and part of the main surfaces 10c. The first external electrode 6 and the second external electrode 8 are insulated so as not to be in contact with each other in the X-axis direction.

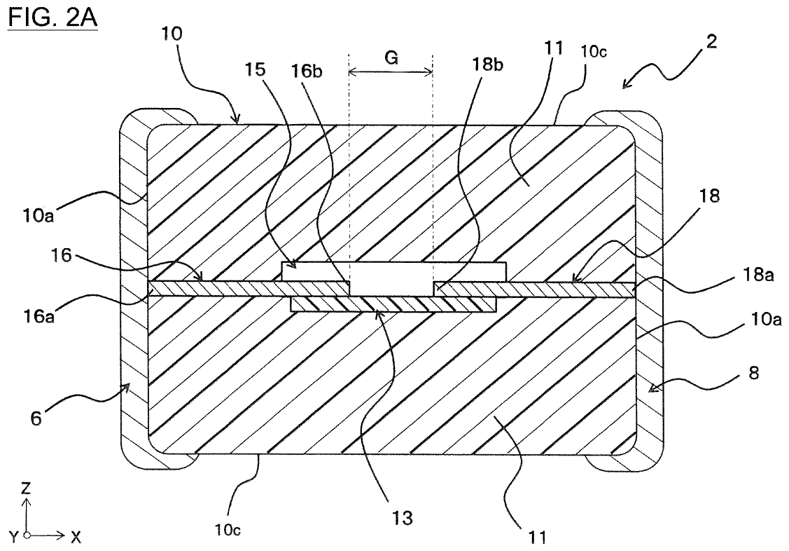

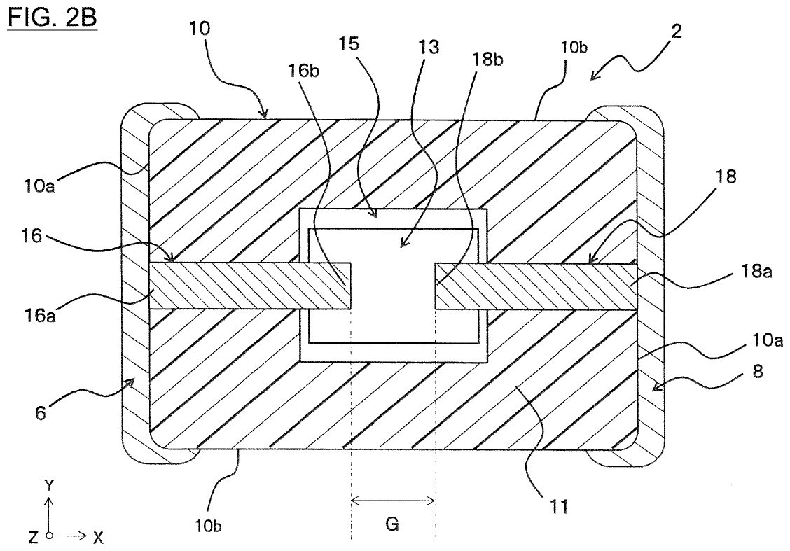

FIG. 2A illustrates an X-Z cross-section of the transient voltage protection device 2 cut substantially at a Y-axial center. In contrast, FIG. 2B illustrates an X-Y cross-section of the transient voltage protection device 2 cut substantially at a Z-axial center. As illustrated in FIGS. 2A and 2B, the element body 10 includes or has insulating layers 11, discharge electrodes 16 and 18 in pairs, a discharge inducing portion 13, and a cavity 15.

All of the insulating layers 11 are of an electrically insulating sintered body and are laminated along the Z-axis direction. The insulating layers 11 are integrated to the extent that boundaries between the adjacent insulating layers 11 cannot be visually recognized. The thickness and the number of the insulating layers 11 are not limited and are appropriately determined according to the dimensions of the element body 10.

One discharge electrode electrically connected to the first external electrode 6 among the discharge electrodes 16 and 18 in pairs is referred to as the first discharge electrode 16 whereas the other discharge electrode electrically connected to the second external electrode 8 is referred to as the second discharge electrode 18. When the term “discharge electrodes 16 and 18” is collectively used in the following description, the description is illustrative of characteristics common to both the first discharge electrode 16 and the second discharge electrode 18.

Each of the discharge electrodes 16 and 18 is an electrode layer having a rectangular shape in plan view and is interposed between predetermined insulating layers 11. Each of the discharge electrodes 16 and 18 may have any average thickness. The average thickness may be, for example, 2 μm or more and 20 μm or less or 3 μm or more and 10 μm or less. The first discharge electrode 16 and the second discharge electrode 18 may have different average thicknesses but may have approximately the same average thickness.

Both the first discharge electrode 16 and the second discharge electrode 18 are laminated on the same insulating layer 11. The distances in the Z-axis direction between the main surfaces 10c and the first discharge electrode 16 and the distances in the Z-axis direction between the main surfaces 10c and the second discharge electrode 18 are substantially the same. That is, the first discharge electrode 16 and the second discharge electrode 18 are located at approximately the same height in the Z-axis direction. However, the first discharge electrode 16 and the second discharge electrode 18 are disposed apart from each other so as not to be in direct contact with each other in the X-axis direction.

The first discharge electrode 16 includes a lead-out portion 16a and an opposing portion 16b. The lead-out portion 16a is an end portion of the first discharge electrode 16 facing outward in the X-axis direction. The lead-out portion 16a is exposed to the corresponding end surface 10a of the element body 10 and is electrically connected to the first external electrode 6. In contrast, the opposing portion 16b is an end portion of the first discharge electrode 16 facing inward in the X-axis direction. The opposing portion 16b is located in the cavity 15 and opposes an opposing portion 18b of the second discharge electrode 18.

The second discharge electrode 18 includes a lead-out portion 18a and the opposing portion 18b. The lead-out portion 18a is an end portion of the second discharge electrode 18 facing outward in the X-axis direction. The lead-out portion 18a is exposed to the corresponding end surface 10a of the element body 10 and is electrically connected to the second external electrode 8. In contrast, the opposing portion 18b is an end portion of the second discharge electrode 18 facing inward in the X-axis direction. The opposing portion 18b is located in the cavity 15 and opposes the opposing portion 16b of the first discharge electrode 16.

The opposing portions 16b and 18b are apart in the X-axis direction; and between the opposing portions 16b and 18b is a gap G. When a voltage not smaller than a predetermined voltage is applied between the first external electrode 6 and the second external electrode 8, electric discharge occurs at the gap G. With the above electric discharge between the opposing portions 16b and 18b, the transient voltage protection device 2 assumes a role in preventing application of a transient voltage to a device under protection (DUP).

The gap G may have any width in the X-axis direction. The width is appropriately determined so that desired discharge characteristics are exhibited. The width of the gap G in the X-axis direction may be, for example, 10 μm or more and 150 μm or less or 30 μm or more and 100 μm or less. The opposing portions of the discharge electrodes opposing each other on the discharge inducing portion 13 may have any length (length of each opposing portion (16b, 18b) in the Y-axis direction). This length may be, for example, 10 μm or more and 500 μm or less or 30 μm or more and 200 μm or less. The ratio of the length of each opposing portion (16b, 18b) in the Y-axis direction to the width of the gap G in the X-axis direction may be, for example, 0.1 or more and 30 or less or 0.5 or more and 10 or less.

The discharge inducing portion 13 is laminated below the discharge electrodes 16 and 18 along the Z-axis so as to be in contact with both discharge electrodes 16 and 18 in the lamination direction. In other words, the discharge inducing portion 13 is provided to extend below the first discharge electrode 16 and the second discharge electrode 18 and connects the opposing portions 16b and 18b. The discharge inducing portion 13 has a substantially rectangular shape in plan view viewed from the lamination direction. The discharge inducing portion 13 may have a width in the X-axis direction larger than the width of the gap G and may have a length in the Y-axis direction larger than the length of each opposing portion in the Y-axis direction. The discharge inducing portion 13 may have any average thickness. This average thickness may be, for example, 1 μm to 15 μm. The discharge inducing portion 13 has a function of making it easier for electric discharge between the first discharge electrode 16 and the second discharge electrode 18 to occur.

In the following description, among surfaces of the discharge inducing portion 13, a surface between the discharge electrodes 16 and 18 is defined as a specific surface 13a.

The specific surface 13a of the transient voltage protection device 2 according to the present embodiment has a surface roughness within a predetermined range. Specifically, Sa, which denotes the arithmetic mean height of the surface roughness of the specific surface 13a, is 100 nm or more and 500 nm or less.

Sa of the specific surface 13a falling within the above range, particularly 100 nm or more, can increase the percentage of air between metal particles 33 more than a small Sa can. Consequently, the transient voltage protection device 2 can have a lower discharge start voltage. Moreover, increasing Sa of the specific surface 13a increases the surface area subject to electric discharge. Thus, ESD resistance can be increased.

An Sa of less than 100 nm does not produce the above effects because of a low percentage of air between the metal particles 33. An Sa of above 500 nm increases the discharge start voltage because of too large a distance between the metal particles 33.

Parameters of the surface roughness of the specific surface 13a other than Sa may be within predetermined ranges. For example, Sz, which denotes the maximum height of the surface roughness of the specific surface 13a, may be 400 nm or more and 2500 nm or less. Ra, which denotes the arithmetic mean height of line roughness of the specific surface 13a, may be 95 nm or more and 500 nm or less. Rz, which denotes the maximum height of the line roughness of the specific surface 13a, may be 400 nm or more and 2500 nm or less.

The cavity 15 is a space formed by burning an organic component (lacquer) out in a manufacturing process of the transient voltage protection device 2. As illustrated in FIG. 2A, surfaces defining the cavity 15 include a surface in the vicinity of the opposing portion 16b of the first discharge electrode 16, a surface in the vicinity of the opposing portion 18b of the second discharge electrode 18, a surface of the discharge inducing portion 13, and a lower surface of the insulating layer 11 located above the discharge electrodes 16 and 18. The cavity 15 may have any shape or dimensions but may be formed so as to cover the opposing portions of the discharge electrodes 16 and 18 and the discharge inducing portion 13 when viewed from the lamination direction. The cavity 15 has a function of absorbing thermal expansion of the first discharge electrode 16, the second discharge electrode 18, the insulating layers 11 near the discharge electrodes 16 and 18, and the discharge inducing portion 13 at the time of electric discharge.

Characteristics of materials or the like of each constituent are described next in detail.

Provided that the insulating layers 11 are composed of an insulating inorganic compound, the insulating layers 11 may have any composition. The insulating layers 11 may contain, for example, one inorganic compound or at least two inorganic compounds selected from the group consisting of Fe₂O₃, NiO, copper oxides (CuO, Cu₂O), ZnO, MgO, SiO₂, TiO₂, MnCO₃, SrCO₃, CaCO₃, BaCO₃, Al₂O₃, ZrO₂, and B₂O₃. The insulating layers 11 may contain, in particular, ZrO₂ or/and a copper oxide. In a situation where at least two inorganic compounds are contained, these inorganic compounds may be present as a complex compound (e.g., CaZrO₃). The insulating layers 11 may also contain, in addition to the above inorganic compound or compounds, glass or a subcomponent compound containing a rare-earth element or the like.

The discharge electrodes 16 and 18 are sintered body layers of conductive metal. That is, the discharge electrodes 16 and 18 predominantly contain the conductive metal as a main component; and the discharge electrodes 16 and 18 may predominantly contain Ag, Pd, Au, Pt, Cu, Ni, Al, Mo, W, or an alloy containing at least one of these metal elements. The discharge electrodes 16 and 18 may predominantly contain at least one selected from the group consisting of Ag, Au, Cu, Pd, and Pt or may predominantly contain at least one selected from the group consisting of Ag, Au, Pd, and Pt. Specifically, the main component may constitute, in total, 30 wt % or more, 50 wt % or more, 80 wt % or more, or 90 wt % or more of the discharge electrodes 16 and 18. By predominantly containing at least one selected from the group consisting of Ag, Au, Pd, and Pt, the discharge electrodes 16 and 18 can be prevented from melting through electric discharge. This easily increases ESD resistance. The discharge electrodes 16 and 18 may contain traces (e.g., 1 wt % or less each) of non-metal components, such as C, S, and P.

The first discharge electrode 16 and the second discharge electrode 18 may contain different main components but may contain the same main component.

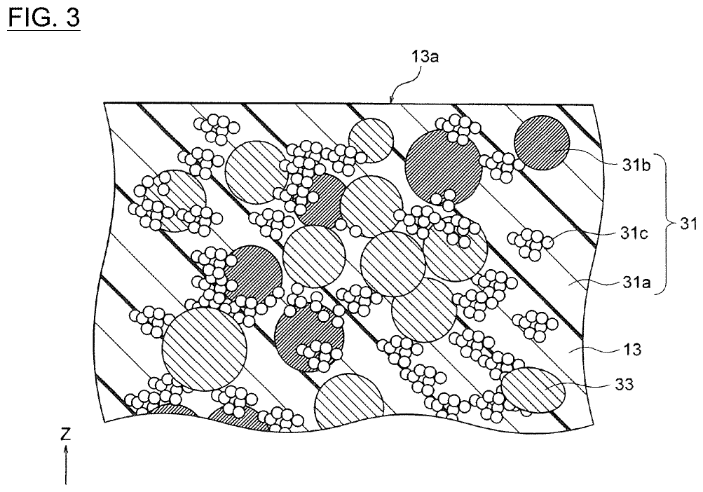

As illustrated in FIG. 3, the discharge inducing portion 13 includes a ceramic component 31 and metal particles 33. The discharge inducing portion 13 may further have pores. The ceramic component 31 of the discharge inducing portion 13 is not limited. The ceramic component 31 may include glass 31a, which is a base material; ceramic particles 31b, which predominantly contain Al₂O₃ (which may hereinafter be simply referred to as Al₂O₃ particles); and transition metal oxide particles 31c. The transition metal is not limited and may contain at least one selected from the group consisting of Mn, Ti, and Zr or at least one selected from the group consisting of Ti and Zr. The transition metal oxide particles 31c may have a higher permittivity than that of the glass 31a and the Al₂O₃ particles 31b. Examples of the transition metal oxide particles 31c with a higher permittivity higher than that of the glass 31a and the Al₂O₃ particles 31b include TiO₂ and ZrO₂. Also, the above transition metal may contain at least one selected from the group consisting of Ti and Zr. In the cross-section illustrated in FIG. 3, the metal particles 33, the Al₂O₃ particles 31b, and the transition metal oxide particles 31c are dispersed in the glass 31a (base material).

In a situation where the transition metal contains at least one selected from the group consisting of Ti and Zr, the discharge inducing portion 13 has a particularly high permittivity. This reduces the discharge start voltage.

The metal particles 33 have a higher melting point (solidus temperature) than the firing temperature of the element body 10. Specifically, as the metal particles 33, Ag particles, Pd particles, Au particles, Pt particles, Cu particles, Ag—Pd alloy particles, Ag—Au alloy particles, Ag—Pt alloy particles, or the like can be used. The metal particles 33 may predominantly contain, as a main component, at least one selected from the group consisting of Ag, Au, Cu, Pd, and Pt or at least one selected from the group consisting of Ag, Au, Pd, and Pt. Specifically, the main component may constitute, in total, 30 wt % or more or 50 wt % or more of each metal particle 33. By predominantly containing at least one selected from the group consisting of Ag, Au, Pd, and Pt, the metal particles 33 can be prevented from melting through electric discharge. This easily increases ESD resistance.

The metal particles 33 may have a median size of 2.0 μm or less or a median size of 0.1 μm or more and 2.0 μm or less in a cross-section of the discharge inducing portion 13. The metal particles 33 may occupy a total area percentage of 10% or more and 50% or less or a total area percentage of 15% or more and 35% or less of a cross-section of the discharge inducing portion 13.

The Al₂O₃ particles 31b may have a median size (D50) of 0.20 μm or more and 1.26 μm or less in a cross-section of the discharge inducing portion 13. Controlling D50 of the Al₂O₃ particles 31b within the above range makes it easier to control the surface roughness of the specific surface 13a of the discharge inducing portion 13 described later within the predetermined range.

The median size and the total area percentage of the metal particles 33 are calculated by observing a cross-section of the discharge inducing portion 13 such as that illustrated in FIG. 3 with an electron microscope (e.g., a scanning electron microscope (SEM) or a scanning transmission electron microscope (STEM)) and performing an image analysis of a resulting cross-sectional photograph. To calculate, for example, the median size of the metal particles 33, circle equivalent diameters of at least one hundred metal particles 33 are preferably measured to obtain particle size distribution of the metal particles 33. A particle size at a volume-based cumulative frequency of 50% in the particle size distribution is calculated as the median size of the metal particles 33. Note that, for calculation of the volume-based cumulative frequency of the metal particles 33, the areas of the metal particles in the cross-section are appropriately converted into their volumes. The total area percentage of the metal particles 33 can be calculated by dividing the total area of the metal particles 33 included in the analyzed cross-section of the discharge inducing portion 13 by the total area of that cross-section. The median size of the Al₂O₃ particles 31b can be calculated similarly.

The glass 31a is in between the metal particles 33 and joins the metal particles 33. As the glass 31a is in between the metal particles 33, the glass 31a contributes to ensuring insulation between the metal particles 33 and compactness of the discharge inducing portion 13. The glass 31a may constitute 15 wt % or more or 30 wt % or more out of 100 wt % of the ceramic component included in the discharge inducing portion 13. The upper limit of the percentage of the glass 31a is not limited. The glass 31a may constitute 100 wt % or less or 60 wt % or less of the ceramic component.

The glass 31a may predominantly contain SiO₂. SiO₂ may constitute 1 wt % to 60 wt % out of 100 wt % of the ceramic component of the discharge inducing portion 13. The glass 31a may appropriately contain other components usually contained in glass. The glass predominantly containing SiO₂ may at least partly include glass particles predominantly containing Si. The glass particles predominantly containing Si indicate glass particles having a Si content of 35 wt % or more in terms of SiO₂. The glass particles predominantly containing Si may have any median size in a cross-section of the discharge inducing portion 13. This median size may be 0.10 μm or more and 1.50 μm or less or may be 0.20 μm or more and 0.50 μm or less.

The ceramic particles predominantly containing Al₂O₃ may have a D50 of 0.20 μm or more and 0.50 μm or less, and the glass particles predominantly containing Si may have a D50 of 0.20 μm or more and 0.50 μm or less. A D50 of 0.1 μm or less makes it difficult to increase the surface roughness. A D50 of 1 μm or more makes it difficult to reduce the surface roughness.

The glass 31a may contain other components, such as SrO, CaO, B₂O₃, and Al₂O₃, in addition to the above main component. The other components may constitute any percentage. For example, B₂O₃ may constitute 0.5 wt % to 15 wt % out of 100 wt % of the ceramic component of the discharge inducing portion 13. SrO may constitute 1 wt % to 30 wt % out of 100 wt % of the ceramic component of the discharge inducing portion 13. CaO may constitute 0.5 wt % to 15 wt % out of 100 wt % of the ceramic component of the discharge inducing portion 13. Al₂O₃ may constitute 1 wt % to 60 wt % out of 100 wt % of the ceramic component of the discharge inducing portion 13. The glass 31a may appropriately contain other components usually contained in glass.

The glass 31a may also contain an alkali metal component (e.g., K₂O or Na₂O). However, the alkali metal component may promote particle growth of the metal particles 33. Thus, the alkali metal component of the discharge inducing portion 13 may constitute 2 wt % or less out of 100 wt % of the ceramic component or may be substantially not contained. That the alkali metal component is substantially not contained means that the alkali metal component constitutes less than 0.1 wt % of the ceramic component. Note that alkali metal is a general term for Li, Na, K, Rb, Cs, and Fr; and the alkali metal component in the present embodiment refers to a compound containing an alkali metal element. Normally, the alkali metal component contained in glass is Li₂O, Na₂O, K₂O, or the like.

The composition of the ceramic component 31 including the glass 31a or the like can be analyzed through various component analyses using, for example, energy-dispersive X-ray spectroscopy (EDX), an electron probe micro-analyzer (EPMA), electron diffraction with a transmission electron microscope (TEM), electron energy loss spectroscopy (EELS), or Auger electron spectroscopy (AES). Using an electron microscope (e.g., a SEM, a STEM, or a TEM), the ceramic component 31 and the metal particles 33 can be distinguished based on contrast in an observation of a cross-section of the discharge inducing portion 13. Using EDX or EPMA, the composition of the metal particles 33 and the composition of the ceramic component 31 including the glass 31a or the like may be analyzed.

As described earlier, the ceramic component 31 of the discharge inducing portion 13 may include the Al₂O₃ particles 31b and the transition metal oxide particles 31c in addition to the glass 31a. As the transition metal oxide particles 31c, at least either TiO₂ particles or ZrO₂ particles may be included. The transition metal oxide particles 31c may have a median size of 10 nm or more and 500 nm or less.

The Al₂O₃ particles 31b may constitute 5 wt % or more and 50 wt % or less out of 100 wt % of the ceramic component of the discharge inducing portion 13. The transition metal oxide particles 31c may constitute 10 wt % or more and 60 wt % or less thereof.

The first external electrode 6 and the second external electrode 8 can each include a baked electrode layer, a resin electrode layer, a plating electrode layer, or the like and may each constitute a single electrode layer or a multilayer including multiple electrode layers. In general, a baked electrode layer or a resin electrode layer is provided as a base electrode in contact with the element body 10, and a single plating electrode layer or multiple plating electrode layers are provided on a surface of the base electrode.

In a situation where a baked electrode layer is provided, the baked electrode layer contains Ag, Cu, Pd, Au, Ni, or an alloy containing at least one of these metal elements, as a conductive material. The baked electrode layer may additionally contain glass frit or oxide particles. In a situation where a resin electrode layer is provided, the resin electrode layer contains a conductive material similar to that of the above baked electrode layer and additionally a thermosetting resin. In a situation where plating electrode layers are provided, the type and the number of the plating electrode layers are determined in view of a mounting method or usage environment of the transient voltage protection device 2. For example, as the plating electrode layers, Ni plating/Sn plating, Cu plating/Ni plating/Sn plating, Ni plating/Pd plating/Au plating, Ni plating/Pd plating/Ag plating, or Ni plating/Ag plating can be adopted.

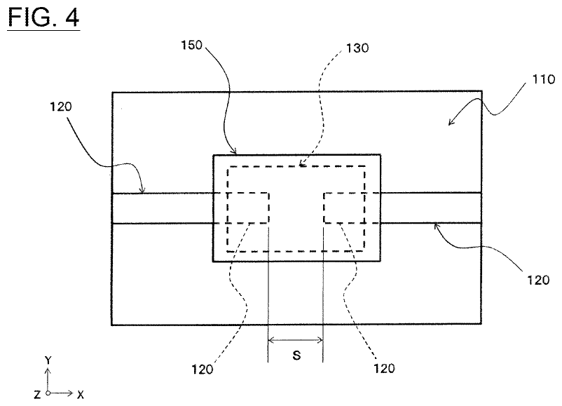

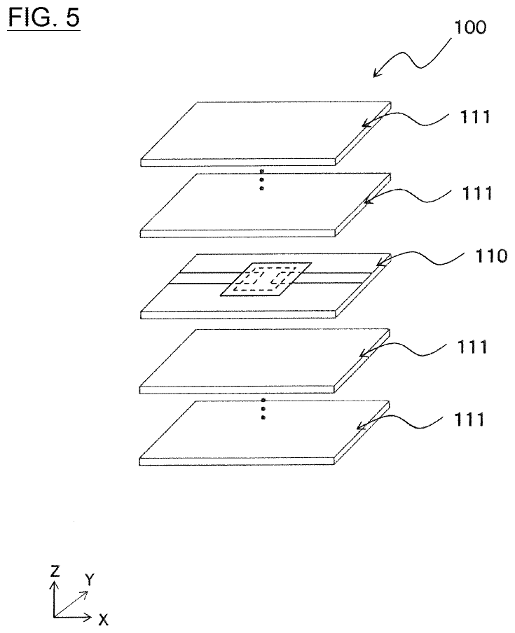

An example method of manufacturing the transient voltage protection device 2 is described next with reference to FIGS. 4 and 5.

First, insulating layer slurry including the constituent components of the insulating layers 11 is prepared. Specifically, the insulating layer slurry is provided by adding a raw material powder of insulating material (e.g., glass frit) to an organic vehicle including an organic solvent and an organic binder and kneading them. Then, the slurry is applied to PET films using a doctor-blade method or the like and is appropriately dried to provide green sheets. In the present embodiment, a sheet on which a discharge portion pattern is printed is referred to as a first green sheet 110, and sheets on which no discharge portion patterns are printed are referred to as second green sheets 111.

Then, a discharge inducing portion pattern 130 illustrated in FIG. 4 is formed on the first green sheet 110 using a discharge inducing portion paste.

For preparation of the discharge inducing portion paste, first, a raw material paste is prepared. The raw material paste is provided by adding raw materials of the ceramic component 31 and a metal powder to an organic vehicle. Examples of the raw materials of the ceramic component 31 include glass frit, which is a raw material of the glass 31a. The composition of the glass 31a can be controlled according to the composition of the glass frit. The glass frit may have any average particle size. This average particle size may be, for example, 0.1 μm or more and 5 μm or less or 0.1 μm or more and 3 μm or less. In a situation where the ceramic particles 31b are added to the discharge inducing portion 13, ceramic powders, such as an Al₂O₃ powder and a transition metal oxide powder (e.g., a ZrO₂ powder and a TiO₂ powder), are added as raw materials of the ceramic particles 31b to the raw material paste. In a situation where the discharge inducing portion is intentionally provided with pores, resin beads (e.g., acrylic beads) or a burn-out material may further be added.

The above burn-out material is a raw material for forming pores and is an organic component that is thermally decomposed to burn out during firing. In the present embodiment, a polymer compound that is soluble in a solvent included in an organic vehicle may be used as the burn-out material. As the solvent of the organic vehicle, organic solvents, such as ethanol, methyl ethyl ketone (MEK), butyl carbitol, or terpineol, are used. Examples of burn-out materials soluble in such organic solvents include a cellulose resin, a phenol resin, an acrylic resin, a urethane resin, and a vinyl chloride resin.

The discharge inducing portion paste is provided by kneading the above raw material paste in three stages, namely a first kneading step to a third kneading step. Controlling a kneader used in each kneading step and kneading conditions of each kneading step can control various surface roughnesses of the discharge inducing portion within the predetermined ranges.

In the present embodiment, for example, a ball mill is used in the first kneading step whereas a bead mill is used in the second kneading step. The bead mill can reduce the size of the glass frit or the powders included in the raw material paste more than the ball mill can.

The kneading time using the ball mill in the first kneading step is not limited. The kneading time may be, for example, 1 hour or more and 24 hours or less. Too short a kneading time using the ball mill makes appropriate kneading using the bead mill difficult. Too long a kneading time using the ball mill reduces manufacturing efficiency.

The kneading time using the bead mill in the second kneading step is not limited. The kneading time may be, for example, 0.5 hours or more and 5 hours or less. Too short a kneading time using the bead mill excessively increases the surface roughness of the discharge inducing portion eventually obtained. Too long a kneading time using the bead mill excessively reduces the surface roughness of the discharge inducing portion eventually obtained. Too large a surface roughness in particular increases the discharge start voltage. Too small a surface roughness in particular increases the discharge start voltage and reduces ESD resistance. There is no need to add all materials other than a metal powder to a single organic vehicle to perform each of the above kneading steps. For example, a raw material paste (a first discharge inducing material) that has gone through the second kneading step with the glass frit and the transition metal oxide powder added to an organic vehicle and another raw material paste (a second discharge inducing material) that has gone through the second kneading step with the Al₂O₃ powder added to an organic vehicle may be prepared separately and may then be mixed. In this situation, the kneading time for the first discharge inducing material using the ball mill and the kneading time for the second discharge inducing material using the ball mill may be the same or may be different. The kneading time for the first discharge inducing material using the bead mill and the kneading time for the second discharge inducing material using the bead mill may be the same or may be different.

Then, the metal powder is added.

Then, the third kneading step is performed to provide the discharge inducing portion paste.

In the third kneading step, for example, a triple-roll mill is used for kneading.

Using the discharge inducing portion paste, the discharge inducing portion pattern 130 is formed with various printing methods (e.g., screen printing), transfer methods, or application methods.

Then, a conductor pattern 120 illustrated in FIG. 4 is formed on the first green sheet 110 using a discharge electrode paste. The discharge electrode paste is manufactured by kneading a conductive powder, which is a raw material of the discharge electrodes 16 and 18, and an organic vehicle. Any method of kneading the discharge electrode paste may be used. For example, a ball mill, a bead mill, a triple-roll mill, a homogenizer, or a high-pressure wet pulverizing apparatus may be used, or at least two of these apparatuses may be used in combination.

The conductor pattern 120 is formed along the X-axis direction so as to extend over a surface of the first green sheet 110 and a surface of the discharge inducing portion pattern 130. The conductor pattern 120 has a slit S having a predetermined width on the surface of the discharge inducing portion pattern 130. This slit S is where the conductor pattern 120 is not printed and becomes the gap G after firing. The conductor pattern 120 can be formed using a method similar to that of the discharge inducing portion pattern 130.

Then, using a cavity lacquer, a cavity pattern 150 is formed on the first green sheet having the discharge inducing portion pattern 130 and the conductor pattern 120 printed. The cavity lacquer includes an organic solvent and an organic binder that burn out during firing. The cavity pattern 150 is used for forming the cavity 15 between the opposing portions of the discharge electrodes 16 and 18. The cavity pattern 150 may be formed so as to cover portions of the conductor pattern 120 that become the opposing portions 16b and 18b and the discharge inducing portion pattern 130 as illustrated in FIG. 4. The above steps provide the first green sheet 110 having the discharge portion pattern printed, which includes the discharge inducing portion pattern 130, the conductor pattern 120, and the cavity pattern 150.

Then, the first green sheet 110 having the discharge portion pattern and the second green sheets 111 are laminated and are pressed in the lamination direction to provide a green chip 100. At this time, the first green sheet 110 is laminated between the second green sheets 111 as illustrated in FIG. 5. The number of the second green sheets 111 is not limited. The number of the second green sheets 111 above the first green sheet 110 and the number of the second green sheets 111 below the first green sheet 110 may be different.

FIGS. 4 and 5 show a process of forming a single green chip for simplified illustration. However, in actual manufacturing steps, normally, a green sheet having larger dimensions in an X-Y planar direction than those of the element body 10 is prepared, and multiple discharge portion patterns are continuously printed on a surface of this green sheet. Then, a mother laminated body is formed using the green sheet, and this mother laminated body is cut at predetermined intervals to provide multiple green chips.

Then, the green chip 100 resulting from the above steps undergoes a firing treatment to provide the element body 10. Conditions of the firing treatment are not limited. Conditions under which the element body 10 is sintered are selected according to the components contained in the element body 10. For example, the holding temperature may be 800° C. to 1200° C. The temperature holding time may be 0.1 to 3 hours. The firing atmosphere may be an air atmosphere, an inert gas atmosphere, or a reducing atmosphere. During the firing treatment, the cavity pattern 150 burns out, and the cavity 15 is formed where the cavity pattern 150 has been laminated. In a situation where the discharge inducing portion pattern 130 contains a polymer compound (burn-out material), this polymer compound (burn-out material) contained in the discharge inducing portion pattern 130 burns out during the firing treatment to form pores in the discharge inducing portion 13. Prior to the firing treatment, a binder removal treatment may be appropriately performed. In a situation where firing is performed in a reducing atmosphere, a reoxidation treatment may be performed after firing, or a heat treatment for removing strain may be performed after firing.

Then, on the surfaces of the element body 10 resulting from the above steps, the external electrodes 6 and 8 in pairs are formed. Methods of forming the external electrodes 6 and 8 are not limited. For example, in a situation where baked electrode layers are formed as the external electrodes 6 and 8, a conductive paste including glass frit is applied to the end surfaces of the element body 10, and then the element body 10 undergoes a heat treatment under predetermined conditions (e.g., at 600° C. to 800° C. for 1 to 5 hours in air).

In a situation where resin electrodes are formed as the external electrodes 6 and 8, a conductive paste including a thermosetting resin is applied to the end surfaces of the element body 10, and then the element body 10 is heated at a temperature at which the thermosetting resin hardens. After the baked electrodes or the resin electrodes are formed using the above method, sputtering, vapor deposition, electrolytic plating, electroless plating, or the like may be further performed to provide the external electrodes 6 and 8 with a multilayer structure.

Through the above manufacturing process, the transient voltage protection device 2 illustrated in FIG. 1 is provided.

### SUMMARY

The transient voltage protection device 2 according to the present embodiment includes the discharge electrodes 16 and 18 in pairs opposing each other with the gap G therebetween and the discharge inducing portion 13 in contact with the discharge electrodes 16 and 18 in pairs. The discharge inducing portion 13 includes the ceramic component 31 and the metal particles 33. The surface roughness Sa of the specific surface 13a of the discharge inducing portion 13 between the discharge electrodes 16 and 18 in pairs is 100 nm or more and 500 nm or less.

The transient voltage protection device 2 can have a lower discharge start voltage and higher ESD resistance by having the above characteristics. A reason why such effects are produced is not necessarily clear. However, it is assumed that inclusion of the highly conductive metal particles 33 and the highly insulating ceramic component 31 in the discharge inducing portion 13 and the surface roughness Sa of the specific surface 13a of the discharge inducing portion 13 falling within the predetermined range make electric discharge easy and make the discharge inducing portion 13 experience less change due to the electric discharge at the same time. Consequently, it is assumed that this can reduce the discharge start voltage and increase ESD resistance.

The metal particles 33 may predominantly contain at least one selected from the group consisting of Ag, Au, Pd, and Pt. Predominantly containing the at least one selected from the group consisting of Ag, Au, Pd, and Pt enables the metal particles 33 to be prevented from melting through electric discharge. This can further increase ESD resistance.

The discharge inducing portion 13 may contain TiO₂ particles and/or ZrO₂ particles as the ceramic particles 31b. Dispersion of the TiO₂ particles in the discharge inducing portion 13 can further reduce the discharge start voltage. Dispersion of the ZrO₂ particles in the discharge inducing portion 13 can further increase ESD resistance.

### Modified Example

The embodiment of the present disclosure has been described above; however, the present disclosure is not construed as limited to the above embodiment and can be variously modified without departing from the gist of the present disclosure.

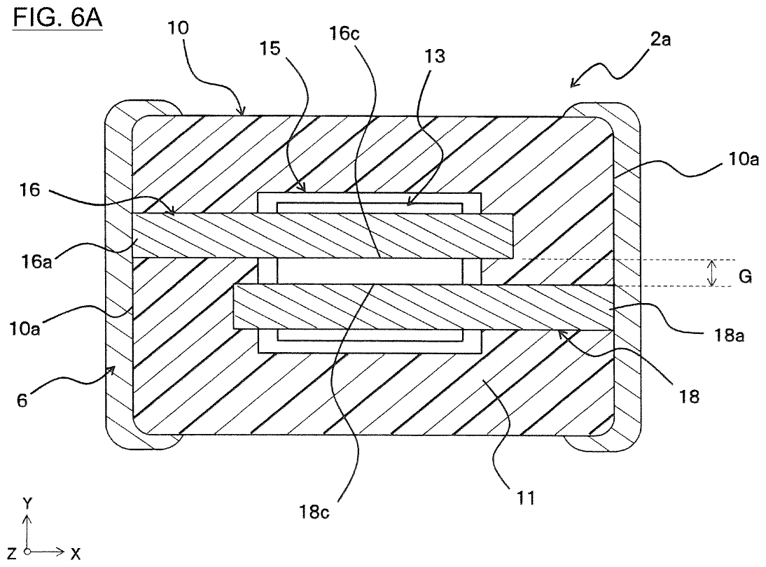

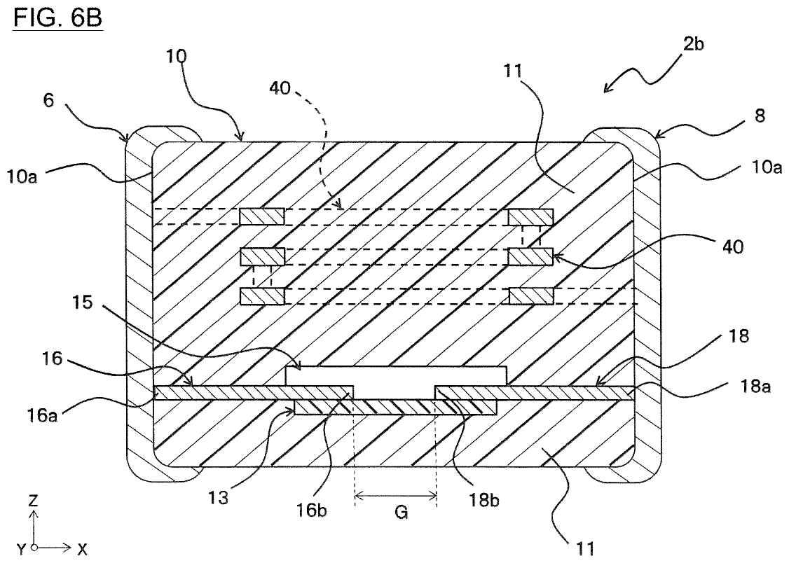

The discharge electrodes 16 and 18 in pairs may, for example, oppose each other in the Y-axis direction. In a transient voltage protection device 2a illustrated in FIG. 6A, a side edge 16c of a first discharge electrode 16 along the Y-axis direction and a side edge 18c of a second discharge electrode 18 along the Y-axis direction oppose each other with a gap G therebetween. That is, the side edges 16c and 18c are opposing portions, and electric discharge upon occurrence of a transient voltage (e.g., ESD) occurs between the side edges 16c and 18c. In a situation where the side edges 16c and 18c of the discharge electrodes 16 and 18 oppose each other as illustrated in FIG. 6A, on a discharge inducing portion 13, the opposing portions of the discharge electrodes 16 and 18 can have a larger length than that of the end-side opposing portions. In the transient voltage protection device 2a illustrated in FIG. 6A, the ratio of the length of the opposing portions to the width of the gap G in the Y-axis direction may be 0.3 or more or may be 0.5 or more and 50 or less.

For example, in FIGS. 2A and 2B, one cavity 15 is provided so as to cover the discharge inducing portion 13 and the opposing portions of the discharge electrodes 16 and 18; however, multiple cavities 15 may be provided above the discharge electrodes 16 and 18 and the discharge inducing portion 13 in the Z-axis direction. Also, provided that the discharge electrodes 16 and 18 in pairs, the discharge inducing portion 13, and the cavity 15 constitute a discharge unit, the element body 10 may include multiple discharge units. Also, it may be that the transient voltage protection device has no cavities 15, and between the discharge electrodes in pairs may be the discharge inducing portion 13.

The element body 10 may include a coil 40 as illustrated in FIG. 6B. The element body 10 may further include a capacitor unit. The capacitor unit can be provided by, for example, laminating internal electrode layers between the insulating layers 11.

### EXAMPLES

Hereinafter, the present disclosure is described based on further detailed examples. However, the present disclosure is not construed as limited to these examples.

### Example 1

Green sheets, a discharge electrode paste, a discharge inducing portion paste, and a cavity lacquer were prepared.

### Green Sheets

Glass frit and an Al₂O₃ powder were added to an organic vehicle to prepare insulating layer slurry. Out of the total volume (100 vol %) of the glass frit and the Al₂O₃ powder, the glass frit constituted 60 vol % whereas the Al₂O₃ powder constituted 40 vol %. The glass frit was made from SiO₂—SrO—CaO—B₂O₃ based glass. Out of the entire glass frit, SiO₂ constituted 40 to 70 wt %, SrO constituted 20 to 40 wt %, CaO constituted 5 to 10 wt %, and B₂O₃ constituted 5 to 10 wt %. The Al₂O₃ powder had an average particle size of 3 μm. The glass frit had an average particle size of 4 μm. The insulating layer slurry was applied to PET films and was dried to provide the green sheets.

### Discharge Electrode Paste

A metal powder was added to an organic vehicle to prepare the discharge electrode paste. The metal powder was a Pd powder with an average particle size of 0.5 μm.

### Discharge Inducing Portion Paste

Glass frit, a metal oxide powder, and a burn-out material (ethyl cellulose) were added to an acetone solvent. The glass frit was the same glass frit used for the insulating layer slurry. The metal oxide powder was a mixed powder including an Al₂O₃ powder with an average particle size of 3 μm and a ZrO₂ powder with an average particle size of 0.05 μm mixed at a volume ratio of 1:2.

After the glass frit, the metal oxide powder, and the burn-out material (ethyl cellulose) were added to the acetone solvent, they were kneaded using a ball mill and a bead mill. Using the ball mill, the above raw materials were kneaded for 5 hours (first kneading step). Then, using the bead mill, they were kneaded for 5 hours (second kneading step).

Then, the kneaded materials were dried, and a metal powder was added thereto. Using a triple-roll mill, they were kneaded to provide the discharge inducing portion paste (third kneading step). The metal powder was a Pd powder with an average particle size of 0.5 μm. Out of the discharge inducing portion paste, the glass frit constituted 16 to 20 vol %, the metal powder constituted 16 to 20 vol %, the metal oxide powder constituted 36 to 40 vol %, and the burn-out material constituted 24 to 28 vol %.

### Cavity Lacquer

An organic binder (ethyl cellulose) was added to an organic solvent (butyl carbitol) to prepare the cavity lacquer.

### Green Chip

The discharge inducing portion paste, the discharge electrode paste, and the cavity lacquer were applied to one green sheet in the order mentioned to form a discharge portion pattern.

Then, the green sheet having the discharge portion pattern printed and the green sheets with no discharge portion patterns were laminated in the predetermined order illustrated in FIG. 5 and were pressed in the lamination direction to provide a mother laminated body. Then, the mother laminated body was cut to provide green chips.

### Transient Voltage Protection Device

Then, each green chip was fired in an air atmosphere at 800° C. to 1200° C. for 0.1 hours to 1 hour to provide an element body (a sintered body). Then, a conductive paste containing Ag was applied to outer surfaces of the element body, and the element body was heated at 700° C. for 1 hour. This formed baked electrodes containing Ag. Through the above steps, a transient voltage protection device having the structures illustrated in FIGS. 1 to 2B was provided.

### Measurement of Surface Roughness of Discharge Inducing Portion

A Z-axially upper surface of the transient voltage protection device having the structures illustrated in FIGS. 1 to 2B was polished to expose a surface of a discharge inducing portion. Then, on the surface of the discharge inducing portion, which was in between discharge electrodes in pairs, five first measurement areas measuring 10 μm×10 μm were determined. Surface roughness of these first measurement areas was measured using Dynamic Force Mode (DFM) of a scanning probe microscope (AFM5000II manufactured by Hitachi High-Tech Corporation).

As for Sa and Sz, specifically, in each of the five first measurement areas, three second measurement areas measuring 4 μm×4 μm were determined at different locations. That is, a total of fifteen second measurement areas were determined. Then, Sa and Sz of each second measurement area were measured. At the time of measurement of Sa of each second measurement area, a component of a wavelength of 0.8 mm or more was removed from height data of the second measurement area. The component of a wavelength of 0.8 mm or more was deemed to be a component generated by surface undulation.

As for Ra and Rz, specifically, in each of the five first measurement areas, three vertical 10-μm measurement lines and three horizontal 10-μm measurement lines were determined. That is, a total of thirty measurement lines were determined. Then, Ra and Rz of each measurement line were measured. At the time of measurement of Ra of each measurement line, a component of a wavelength of 0.8 mm or more was removed from height data of the measurement line. The component of a wavelength of 0.8 mm or more was deemed to be a component generated by surface undulation.

Table 2 shows average Sa of a total of fifteen second measurement areas, average Sz of a total of fifteen second measurement areas, average Ra of a total of thirty measurement lines, and average Rz of a total of thirty measurement lines.

Measurement of D50 of Al₂O₃ Particles

The discharge inducing portion of each sample was cut in a direction perpendicular to the surface of the discharge inducing portion. The resultant cross-section was polished. Then, the cross-section was observed with STEM-EDS (JEM-2100F manufactured by JEOL Ltd.). In the cross-section, ten third measurement areas measuring 7 μm×7 μm were determined. Al elemental mapping images of the respective third measurement areas were obtained. Al₂O₃ particles included in the elemental mapping images were identified. All the elemental mapping images were analyzed with Mac-View (manufactured by MOUNTECH Co., Ltd.) to calculate D50 of the Al₂O₃ particles. Table 2 shows the results.

### Measurement of D50 of Glass Particles Predominantly Containing Si

Si elemental mapping images of the respective third measurement areas were obtained with STEM-EDS (JEM-2100F manufactured by JEOL Ltd.). Glass particles predominantly containing Si included in the elemental mapping images were identified. All the elemental mapping images were analyzed with Mac-View (manufactured by MOUNTECH Co., Ltd.) to calculate D50 of the glass particles predominantly containing Si. Table 2 shows the results.

### Evaluation of Discharge Characteristics

The discharge start voltage and ESD resistance of each sample were measured using the electrostatic discharge immunity test defined by IEC 61000-4-2. A discharge start voltage of 2.2 kV or less was deemed good. A discharge start voltage of 1.8 kV or less was deemed better. An ESD resistance of 14 kV or more was deemed good. An ESD resistance of 17 kV or more was deemed better.

### Example 2

Example 2 was carried out as in Example 1 except that the time for which the bead mill was used during the preparation of the discharge inducing portion paste was 2 hours.

### Example 3

Example 3 was carried out as in Example 1 except that the time for which the bead mill was used during the preparation of the discharge inducing portion paste was 0.5 hours.

### Example 4

Example 4 was carried out as in Example 1 except that the metal particles used for the preparation of the discharge inducing portion paste constituted a Pt powder with an average particle size of 0.5 μm.

### Example 5

Example 5 was carried out as in Example 1 except that the metal particles used for the preparation of the discharge electrode paste constituted a Pt powder with an average particle size of 0.5 μm.

### Example 6

Example 6 was carried out as in Example 1 except that the metal particles used for the preparation of the discharge inducing portion paste constituted a Ag—Pd alloy powder with an average particle size of 0.5 μm. The ratio of Ag to Pd in the Ag—Pd alloy powder was 7:3 in weight ratio.

### Example 7

Example 7 was carried out as in Example 1 except that the metal particles used for the preparation of the discharge electrode paste constituted a Ag—Pd alloy powder with an average particle size of 0.5 μm. The ratio of Ag to Pd in the Ag—Pd alloy powder was 7:3 in weight ratio.

### Example 8

Example 8 was carried out as in Example 1 except that the metal particles used for the preparation of the discharge inducing portion paste constituted a Au powder with an average particle size of 0.5 μm.

### Example 9

Example 9 was carried out as in Example 1 except that the metal particles used for the preparation of the discharge electrode paste constituted a Au powder with an average particle size of 0.5 μm.

### Example 10

Example 10 was carried out as in Example 1 except that the metal oxide powder for the discharge inducing portion paste was a mixed powder including an Al₂O₃ powder with an average particle size of 3 μm and a TiO₂ powder with an average particle size of 0.05 μm mixed at a volume ratio of 1:2.

### Example 11

Example 11 was carried out as in Example 1 except for the preparation of the discharge inducing portion paste. In Example 11, two types of discharge inducing materials were prepared.

### First Discharge Inducing Material

Glass frit, a metal oxide powder, and a burn-out material (ethyl cellulose) were added to an acetone solvent. The glass frit was the same glass frit used for the insulating layer slurry. The metal oxide powder was a ZrO₂ powder with an average particle size of 0.05 μm.

After the glass frit, the metal oxide powder, and the burn-out material (ethyl cellulose) were added to the acetone solvent, they were mixed using a ball mill and a bead mill to provide a first discharge inducing material. The above raw materials were mixed for 5 hours using the ball mill and then for 5 hours using the bead mill to provide the first discharge inducing material.

### Second Discharge Inducing Material

A metal oxide powder and a burn-out material (ethyl cellulose) were added to an acetone solvent. The metal oxide powder was an Al₂O₃ powder with an average particle size of 3 μm.

The ratio of the Al₂O₃ powder to the ZrO₂ powder was 1:2 in terms of volume.

After the metal oxide powder and the burn-out material (ethyl cellulose) were added to the acetone solvent, they were mixed using a ball mill and a bead mill to provide a second discharge inducing material. The above raw materials were mixed for 6 hours using the ball mill and then for 2 hours using the bead mill.

### Discharge Inducing Material

The first discharge inducing material and the second discharge inducing material were mixed and were dried to prepare a discharge inducing material. After that, Example 11 was carried out as in Example 1.

### Example 12

Example 12 was carried out as in Example 11 except that the time for which the bead mill was used during the preparation of the first discharge inducing material was 0.5 hours.

### Example 13

Example 13 was carried out as in Example 1 except that the metal particles used for the preparation of the discharge inducing portion paste constituted a Cu powder with an average particle size of 0.5 μm and that the firing atmosphere was a low-oxygen atmosphere.

### Example 14

Example 14 was carried out as in Example 1 except that the metal particles used for the preparation of the discharge electrode paste constituted a Cu powder with an average particle size of 0.5 μm and that the firing atmosphere was a low-oxygen atmosphere.

### Example 15

Example 15 was carried out as in Example 1 except that the metal oxide powder used for the preparation of the discharge inducing portion paste was partly changed from the ZrO₂ powder to a MnO₂ powder.

### Example 16

Example 16 was carried out as in Example 1 except that the metal oxide powder used for the preparation of the discharge inducing portion paste was partly changed from the ZrO₂ powder to the following mixed powder. The mixed powder was prepared by mixing a ZrO₂ powder with an average particle size of 0.05 μm and a TiO₂ powder with an average particle size of 0.05 μm at a volume ratio of 1:1.

### Example 17

Example 17 was carried out as in Example 1 except that the Al₂O₃ powder used for the preparation of the discharge inducing portion paste had an average particle size of 1 μm and that the glass frit used for the preparation of the discharge inducing portion paste had an average particle size of 1 μm.

### Example 18

Example 18 was carried out as in Example 1 except that the Al₂O₃ powder used for the preparation of the discharge inducing portion paste had an average particle size of 0.5 μm and that the glass frit used for the preparation of the discharge inducing portion paste had an average particle size of 0.6 μm.

### Comparative Example 1

Comparative Example 1 was carried out as in Example 1 except that the time for which the bead mill was used during the preparation of the discharge inducing portion paste was 10 hours.

### Comparative Example 2

Comparative Example 2 was carried out as in Example 1 except that no bead mills were used during the preparation of the discharge inducing portion paste.

### Comparative Example 3

Comparative Example 3 was carried out as in Example 1 except that the metal oxide powder for the discharge inducing portion paste was a ZrO₂ powder with an average particle size of 0.05 μm and that no bead mills were used.

TABLE 1

| | | | | | | | | Second discharge | | | Discharge |
|---|---|---|---|---|---|---|---|---|---|---|---|
| | | First discharge inducing material | | | | | | inducing material | | | inducing |
| | | | | | | Ball | Bead | | Ball | Bead | material |
| | Discharge | | | | | mill | mill | | mill | mill | Metal |
| | electrodes | Al₂O₃ | Zro₂ | TiO₂ | MnO₂ | (h) | (h) | Al₂O₃ | (h) | (h) | particles |
| Example 1 | Pd | Contained | Contained | Not contained | Not contained | 5 | 5 | Not contained | | | Pd |
| Example 2 | Pd | Contained | Contained | Not contained | Not contained | 5 | 2 | Not contained | | | Pd |
| Example 3 | Pd | Contained | Contained | Not contained | Not contained | 5 | 0.5 | Not contained | | | Pd |
| Example 4 | Pd | Contained | Contained | Not contained | Not contained | 5 | 5 | Not contained | | | Pt |
| Example 5 | Pt | Contained | Contained | Not contained | Not contained | 5 | 5 | Not contained | | | Pd |
| Example 6 | Pd | Contained | Contained | Not contained | Not contained | 5 | 5 | Not contained | | | AgPd |
| Example 7 | AgPd | Contained | Contained | Not contained | Not contained | 5 | 5 | Not contained | | | Pd |
| Example 8 | Pd | Contained | Contained | Not contained | Not contained | 5 | 5 | Not contained | | | Au |
| Example 9 | Au | Contained | Contained | Not contained | Not contained | 5 | 5 | Not contained | | | Pd |
| Example 10 | Pd | Contained | Not contained | Contained | Not contained | 5 | 5 | Not contained | | | Pd |
| Example 11 | Pd | Not contained | Contained | Not contained | Not contained | 5 | 5 | Contained | 6 | 2 | Pd |
| Example 12 | Pd | Not contained | Contained | Not contained | Not contained | 5 | 0.5 | Contained | 6 | 2 | Pd |

| | | | | | | | | | |
|---|---|---|---|---|---|---|---|---|---|
| Example 13 | Pd | Contained | Contained | Not contained | Not contained | 5 | 5 | Not contained | Cu |
| Example 14 | Cu | Contained | Contained | Not contained | Not contained | 5 | 5 | Not contained | Pd |
| Example 15 | Pd | Contained | Not contained | Not contained | Contained | 5 | 5 | Not contained | Pd |
| Example 16 | Pd | Contained | Contained | Contained | Not contained | 5 | 5 | Not contained | Pd |
| Example 17 | Pd | Contained | Contained | Not contained | Not contained | 5 | 5 | Not contained | Pd |
| Example 18 | Pd | Contained | Contained | Not contained | Not contained | 5 | 5 | Not contained | Pd |
| Comparative | Pd | Contained | Contained | Not contained | Not contained | 5 | 10 | Not contained | Pd |
| Example 1 | | | | | | | | | |
| Comparative | Pd | Contained | Contained | Not contained | Not contained | 5 | 0 | Not contained | Pd |
| Example 2 | | | | | | | | | |
| Comparative | Pd | Not contained | Contained | Not contained | Not contained | 5 | 0 | Not contained | Pd |
| Example 3 | | | | | | | | | |

TABLE 2

| | | | | | | | | | | Dis- | |
|---|---|---|---|---|---|---|---|---|---|---|---|
| | | Discharge inducing portion | | | | | | | | charge | |
| | | | Transition | | | | | Al₂O₃ | Glass | start | ESD |
| | Discharge | Metal | metal oxide | Sa | Sz | Ra | Rz | D50 | D50 | voltage | resistance |
| | electrodes | particles | particles | (nm) | (nm) | (nm) | (nm) | (um) | (um) | (kV) | (kV) |
| Example 1 | Pd | Pd | ZrO₂ | 148 | 755 | 122 | 620 | 0.35 | 0.85 | 1.6 | 17 |
| Example 2 | Pd | Pd | ZrO₂ | 405 | 2120 | 401 | 1994 | 1.26 | 0.74 | 1.8 | 19 |
| Example 3 | Pd | Pd | ZrO₂ | 500 | 2612 | 487 | 2422 | 1.70 | 1.30 | 2.2 | 18 |
| Example 4 | Pd | Pt | ZrO₂ | 225 | 1198 | 223 | 1063 | 0.72 | 0.35 | 1.7 | 17 |
| Example 5 | Pt | Pd | ZrO₂ | 167 | 820 | 156 | 729 | 0.56 | 0.20 | 1.8 | 18 |
| Example 6 | Pd | AgPd | ZrO₂ | 100 | 478 | 98 | 437 | 0.20 | 0.84 | 1.9 | 14 |
| Example 7 | AgPd | Pd | ZrO₂ | 139 | 709 | 125 | 645 | 0.31 | 0.99 | 1.9 | 15 |
| Example 8 | Pd | Au | ZrO₂ | 352 | 1865 | 323 | 1707 | 0.89 | 0.23 | 1.5 | 18 |
| Example 9 | Au | Pd | ZrO₂ | 192 | 1033 | 187 | 981 | 0.67 | 0.76 | 1.5 | 17 |
| Example 10 | Pd | Pd | ZrO₂ | 303 | 1664 | 293 | 1485 | 1.00 | 1.11 | 1.4 | 19 |
| Example 11 | Pd | Pd | ZrO₂ | 145 | 715 | 139 | 696 | 0.70 | 0.13 | 1.9 | 16 |
| Example 12 | Pd | Pd | ZrO₂ | 443 | 2378 | 420 | 2184 | 1.0 | 0.41 | 2.1 | 17 |
| Example 13 | Pd | Cu | ZrO₂ | 151 | 818 | 134 | 630 | 0.41 | 1.03 | 1.8 | 17 |
| Example 14 | Cu | Pd | ZrO₂ | 155 | 709 | 142 | 673 | 0.98 | 0.45 | 2.0 | 16 |
| Example 15 | Pd | Pd | MnO₂ | 335 | 1061 | 312 | 1011 | 0.75 | 1.20 | 2.2 | 15 |
| Example 16 | Pd | Pd | TiO₂, | 415 | 1975 | 358 | 1784 | 1.15 | 0.72 | 1.4 | 18 |
| | | | ZrO₂ | | | | | | | | |
| Example 17 | Pd | Pd | ZrO₂ | 103 | 477 | 95 | 450 | 0.43 | 0.47 | 1.3 | 18 |
| Example 18 | Pd | Pd | ZrO₂ | 110 | 482 | 102 | 432 | 0.22 | 0.21 | 1.3 | 19 |
| Comparative | Pd | Pd | ZrO₂ | 75 | 371 | 74 | 356 | 0.11 | 0.88 | 2.5 | 12 |
| Example 1 | | | | | | | | | | | |
| Comparative | Pd | Pd | ZrO₂ | 688 | 3506 | 617 | 3199 | 2.03 | 0.39 | 3.1 | 17 |
| Example 2 | | | | | | | | | | | |
| Comparative | Pd | Pd | ZrO₂ | 579 | 3032 | 566 | 2976 | Not | 0.27 | 3.2 | 15 |
| Example 3 | | | | | | | | contained | | | |

According to Tables 1 and 2, Examples 1 to 18, in which the surface roughness Sa of the surface of the discharge inducing portion was 100 nm or more and 500 nm or less, had good discharge characteristics, i.e., a low discharge start voltage and high ESD resistance. In contrast, Comparative Example 1, in which Sa was too small, and Comparative Examples 2 and 3, in which Sa was too large, had inferior discharge characteristics.

### REFERENCE NUMERALS

2, 2a, 2b . . . transient voltage protection device
10 . . . element body
10a . . . end surface
10b . . . side surface
10c . . . main surface
11 . . . insulating layer
13 . . . discharge inducing portion
13a . . . specific surface
31 . . . ceramic component
31a . . . glass
31b . . . . Al₂O₃ particle
31c . . . transition metal oxide particle
33 . . . metal particle
16 . . . first discharge electrode
18 . . . second discharge electrode
16a, 18a . . . lead-out portion
16b, 18b . . . opposing portion
16c, 18c . . . side edge
15 . . . cavity
6 . . . first external electrode
8 . . . second external electrode
40 . . . coil
100 . . . green chip
110 . . . first green sheet
120 . . . conductor pattern
130 . . . discharge inducing portion pattern
150 . . . cavity pattern
111 . . . second green sheet

1. A transient voltage protection device comprising:
discharge electrodes in pairs apart with a gap therebetween; and
a discharge inducing portion having a surface exposed to the gap and being in contact with the discharge electrodes in pairs,
wherein
the discharge inducing portion comprises a ceramic component and metal particles, and
the surface of the discharge inducing portion between the discharge electrodes in pairs has a surface roughness Sa of 100 nm or more and 500 nm or less.

2. The transient voltage protection device according to claim 1, wherein the ceramic component of the discharge inducing portion comprises
glass predominantly comprising SiO₂,
ceramic particles predominantly comprising Al₂O₃, and
oxide particles having a higher permittivity than that of the glass and the ceramic particles.

3. The transient voltage protection device according to claim 2, wherein the ceramic particles predominantly comprising Al₂O₃ have a D50 of 0.20 μm or more and 1.26 μm or less in a cross-section of the discharge inducing portion.

4. The transient voltage protection device according to claim 2, wherein
the ceramic particles predominantly comprising Al₂O₃ have a D50 of 0.20 μm or more and 0.50 μm or less in a cross-section of the discharge inducing portion,
the glass predominantly comprising SiO₂ at least partly comprises glass particles predominantly comprising Si, and
the glass particles predominantly comprising Si have a D50 of 0.20 μm or more and 0.50 μm or less.

5. The transient voltage protection device according to claim 2, wherein the oxide particles comprise an oxide of at least one element selected from the group consisting of Ti and Zr.

6. The transient voltage protection device according to claim 1, wherein the metal particles predominantly comprise at least one selected from the group consisting of Ag, Au, Pd, and Pt.

7. The transient voltage protection device according to claim 1, wherein the discharge electrodes predominantly comprise at least one selected from the group consisting of Ag, Au, Pd, and Pt.

8. The transient voltage protection device according to claim 1, wherein the surface of the discharge inducing portion has an Sz of 400 nm or more and 2500 nm or less.

9. The transient voltage protection device according to claim 1, wherein the surface of the discharge inducing portion has an Ra of 95 nm or more and 500 nm or less.

10. The transient voltage protection device according to claim 1, wherein the surface of the discharge inducing portion has an Rz of 400 nm or more and 2500 nm or less.

11. The transient voltage protection device according to claim 1, wherein the metal particles have a median size of 2.0 μm or less in a cross-section of the discharge inducing portion.

12. The transient voltage protection device according to claim 1, wherein the metal particles occupy a total area percentage of 10% or more and 50% or less of a cross-section of the discharge inducing portion.

13. The transient voltage protection device according to claim 2, wherein the glass is included in the discharge inducing portion by 15 wt % or more and 60 wt % or less out of 100 wt % of the ceramic component of the discharge inducing portion.

14. The transient voltage protection device according to claim 13, wherein SiO₂ contained in the glass constitutes 1 wt % to 60 wt % out of 100 wt % of the ceramic component of the discharge inducing portion.

15.-16. (canceled)
